(19) United States
(12) Patent Application Publication
(10) Pub. No.: US 2004/0199875 A1
(43) Pub. Date: Oct. 7, 2004

(54) Method for hosting analog written materials in a networkable digital library

(76) Inventor: Jason Kyle Samson, Omaha, NE (US)

Correspondence Address: Jason K Samson, 3841 N. 65th Ave., Omaha, NE, 68104, US

(21) Appl. No.: 10/405,754

(22) Filed: Apr. 3, 2003

(51) Int. Cl. G06F 15/00

(52) U.S. Cl. 715/523

(57) ABSTRACT

This invention claims a unique method for storing and hosting analog content (e.g. print book, film, etc.) in a digital library over a network (e.g. Internet). This method dramatically reduces the cost of hosting these analog materials when machine readable text does not yet exist. This method simultaneously provides the important benefits offered by the more expensive traditional digitization methods including full content searchability and high viewable accuracy. The method achieves these goals at a substantially lower cost by eliminating the need for the most expensive phase of digitization, the manual correction of OCR errors. By hosting pixel-based images alongside the OCR-generated text, researchers gain 100% readable accuracy in addition to full content searchability at an affordable price. The value of this method is further enhanced through the use of textual channels that offer accuracy improvements over uncorrected OCR without the expense of manual OCR error correction.

### TECHNICAL FIELD

The invention relates to hosting analog, written materials in a digital library that services library users primarily for the purpose of research.

### BACKGROUND OF THE INVENTION

At the time of this invention, mass amounts of written materials are being hosted in digital libraries all around the world. The vast majority of this material, however, is limited to written material that originated in some electronic form that was preserved subsequent to the publication. Written materials where no such electronic form was preserved are far less likely to be hosted in a digital library. The reason for this is primarily economic.

The cost of hosting non-electronic (analog) written materials in a manner that is satisfactory to publishers, authors and researchers has been prohibitively high prior to this invention. The cost in most cases is thousands of US dollars per typical volume or unit. This high cost is largely due to the false assumption that the only solution that will satisfy the demands of publishers, authors and researchers is a single form that meets these demands. This single form has typically been in the form of a highly accurate (at least 99.9% accurate eBook. Such eBooks are typically textual with embedded graphics. Given the assumption that a single form such as a typical eBook is necessary, it is understandable why hosting analog written materials in a digital library is so expensive.

The primary demands of publishers, authors and researchers include high textual accuracy, full content searchability, acceptable performance including reasonable download times using Internet connections, and a fairly accurate representation of the layout and typesetting of the originally published written material. To achieve these objectives in a single digital form, an expensive eBook or similar approach is indeed necessary. Evidence that this is in fact the approach used in digital libraries at the time of this invention can be found by referencing all of the significant Internet-based digital libraries built. These libraries either use a single, expensive digital form like the eBook described above, or they fail to meet the one or more of the basic demands of the publishers, authors and researchers listed above.

The following are the most significant commercial, Internet-based digital libraries at the time of this invention: Questia, netLibrary, and ebrary. They each use a single eBook or similar form for achieving all of the demands of publishers, authors and researchers. They have each also undergone serious financial strain or even bankruptsy due largely to the overwhelming costs of producing these eBooks. The fact that these industry leaders all share in this same “single form” approach is evidence that the prior art has not considered the solution set forth in this invention.

The highest portion of the cost of the prior art resides in the phase of development where the textual accuracy is improved to an acceptable level, often 99.9% or higher, and the format is made sufficiently representative of the analog work. The phase of development prior to this typically involves scanning the analog work and then processing the work through an OCR program. The expensive phase follows, which requires high levels of manual labor to correct the errors from the OCR output. The cost of this manual labor is primarily what makes the production of a satisfactory eBook so expensive.

It is important to note that some of the analog written materials that exist are not under copyright protection, and are commonly referred to as “public domain” materials. Most publications made prior to year 1923 fall in this category. For these materials, the demands of publishers and authors are for the most part not enforceable. Furthermore, royalties do not have to be paid to make these materials publicly available. For these materials, quality is not as critical, and may be as low as the research consumers are willing to accept, which may be as low as 95 percent accuracy depending on library fees, and almost any level of accuracy if there is no library fee. Furthermore, for these public domain materials, preserving an accurate representation of the format and typesetting of the original published work is not necessary. Since there are inexpensive ways to achieve the remaining objectives through use of scanning and OCR programs, there is little room for cost reduction of hosting these materials. Therefore, the present invention is designed with the copyrighted materials in mind, which do require all four of the demands mentioned previously.

It is also important to note that much of the more recent written material that has been published within the past decade has originated in some electronic form that is preserved and may be inexpensively converted to an eBook form for hosting in a digital library. Since there is little room for cost-reduction in this conversion process, the invention is not designed with these materials in mind.

The invention is primarily addressing the large gap in between the public domain materials, and the recent materials for which electronic forms have been preserved. This gap primarily covers the range of materials published from year 1923 into the early to mid 1990's. It is this mass collection of materials that are extremely expensive to host in a digital library in a way that satisfies the demands of publishers, authors and researchers, assuming the approach of the prior art is maintained.

This invention provides utility to this problem by simultaneously meeting the demands of the publishers, authors and researchers while at the same time, drastically reducing the cost of hosting these materials. This is done by adopting a multi-form approach to the problem, as opposed to a single-form approach. By removing the assumption that a single form must meet all of the demands, multiple forms may be integrated into an overall digital library solution, where each form adds its own strengths to the solution, such that, when taken together with the other forms, the demands of the publishers, authors and researchers are sufficiently met. The utility, however, resides in the fact that forms may be chosen that are very inexpensive to produce, requiring minimal manual labor. The cost of producing these multiple forms may be far less expensive than the single form of the prior art since manual labor, the greatest expense of the prior art, will be largely eliminated.

### SUMMARY OF THE INVENTION

This invention is a digital library solution for hosting analog written materials in a way that integrates multiple digital forms that are each inexpensive to produce, and yet when combined, satisfy the demands of publishers, authors and researchers. The two primary forms that this invention implements are 1) a scanned or digitally photographed graphical image of each page or segment of analog written material, and 2) an OCR-generated textual representation of each page or segment of written material that need not be manually corrected to achieve a high level of accuracy. The first form satisfies the demands of publishers and authors for highly accurate presentation both in terms of textual content as well as formatting and typesetting. In fact, by using the first form, the accuracy is essentially 100% on all accounts since it is literally a “picture-perfect” representation of the printed page. This form actually exceeds the viewable accuracy of any eBook form. The second form is needed to cater to the demands of researchers, including the demands for acceptable performance and full content searchability. Since the combination of these forms is far less expensive than a single, accurate eBook form, the cost for developing a large library using this invention is drastically reduced. This makes hosting of thousands of copyrighted analog works affordable. The order of magnitude of this cost reduction may typically be from over $2,000 US dollars for a typical eBook to as low as $100 US dollars for a typical book using this invention. Had the prior art included this invention, the digital libraries available today would be much larger than they are (the largest to date being only 65,000 volumes—the size of a relatively small physical library), and affordable access would be offered to the public without creating financial strain on either the library (such as the strain present in all three of the largest libraries) or on the researchers who would most likely have to absorb the high costs through library fees.

### DETAILED DESCRIPTION

The invention is comprised of hosting multiple digital forms of analog written material, where one of the forms must incorporate a graphical representation of the material, the preferred embodiment of which would consist of pixel-based images captured from each page of the written material. The resolution and tonality of this image may vary, but will likely be most effective at approximately 300 dpi gray-scale, which is typically most effective for OCR processing to generate the OCR channels. These graphical images may then be downsampled and resized for storage at a lower resolution optimized for on-screen display at approximately 72 dpi. Downsampling and compression algorithms such as GIF or JPEG may also be used to reduce file size for optimal performance when transmitted for display over the Internet. The original 300 dpi capture may be readily accomplished using an optical scanner or a digital camera.

At least one textual form or channel must also be used in order to meet the demand by researchers for full content searchability and acceptable performance. Textual data by definition makes these two demands simple to achieve since textual data requires minimal data storage capacity in contrast to graphical data for the same content, and since searchability is a basic feature of most text-rendering software, including virtually all web browsers and databases. Those skilled in the art will recognize that many effective searching mechanisms could be implemented in order to attain full content searchability from textual data. The preferred embodiment is essentially a matter of choosing which of the claimed textual forms or channels should be used along with the graphical form.

The choice of textual form or channel is simply a matter of assessing the relative reliability of each channel and ranking them accordingly. It is estimated that this reliability ranking would typically fall in the following order, from most reliable to least: 1) supplied channels 2) user channels 3) super channels 4) individual OCR channels from highest to lowest accuracy. Assuming that this ranking was validated to be the best assumption, then if a supplied channel is available and inexpensive, it would be the preferred embodiment of the textual form. If no such supplied channel is inexpensively available, then if a user has taken the time to produce a user channel from other lower quality channels, then it is reasonable to assume that this user channel would be the next best choice. If no user has created a user channel, then a super channel will most likely be the most accurate textual form and would be preferred. The least preferred form would be one or more OCR channels, but in the absence of other textual forms, this would still satisfy the minimum requirement of including at least one textual form. A central benefit of this invention is that even when the least preferred textual forms are used, the entire solution still meets the essential demands of publishers, authors and researchers since the accuracy is already satisfied by the “picture perfect” graphical form.

It is quite likely that for most analog written materials in a large library, initially there will not be any supplied channels, nor user channels available. So it is expected that the best available option will be to create as many OCR channels as deemed beneficial, and then generate one super channel from the best of those OCR channels. For example, consider the use of 5 OCR programs, three of which are excellent in terms of textual accuracy, one of which is not as accurate but provides some useful formatting information about each page, and another that is best at handling pages that include words from multiple languages. Running each of these OCR programs against the graphical forms will yield 5 respective OCR channels. Depending on the content of the work being digitized, three, four, or perhaps all five of these OCR channels might be used to generate one super channel. By doing this, often where one OCR program errs, one of the other OCR programs may not. In this way, by devising an algorithm to select the OCR channel that is most reliable on any given word, a super channel may be compiled that could potentially have an accuracy far higher than any single OCR channel. Furthermore, dictionaries may also be checked for spelling matches against the various OCR channels.

Those skilled in the art will recognize that many algorithms could be devised to make the decision on a word-by-word or character-by-character basis as to which OCR channel is correct. The preferred algorithm will most likely involve assigning a weighted rating to each OCR channel, where the weight is increased by some appropriate amount if the spelling matches a dictionary entry, and possible further weight adjustments depending on how “commonly-used” the matching word in the dictionary is. The weights assigned to each OCR channel may also be influenced by historical performance of the corresponding OCR program in comparison to the other OCR programs.

The preferred embodiment for storage is as follows: After digitization, the graphical files of each segment or page of material are stored on a networkable file system. The textual channels are stored in a networkable relational database. All forms are keyed and indexed to some meaningful reference of the analog segments of material they represent, such as a book and page identification code. This way, searches against the textual data can locate and retrieve the graphical form for display as easily as they can any textual form or channel. Those skilled in the art will recognize that many search engines, tables, and indices may also be created to obtain maximum flexibility and performance for searching the textual channels.

The preferred embodiment for display would include a remotely-networkable (e.g. Internet-based) graphical user interface that allows users to view the library contents in a form of their choosing. Those skilled in the art will recognize that this display may be designed in many ways. The key to the invention is that all presentations of analog materials that are hosted in the digital library exist in a minimum of at least one graphical form and at least one textual form. Whether these forms are displayed together, displayed in tandem, or chosen for display by the user on-the-fly is not critical to the merit of this invention. The bottom line is that users have the choice of which form will most effectively meet their present needs. For instance, when skimming through large amounts of material in search of relevant information for a research topic, the user will likely prefer a textual form, because it is the fastest and is searchable. However, when a researcher is finalizing a research project and needs to firm up citations and quotes, they will most likely prefer the graphical form, since it offers picture-perfect accuracy. In this way, the two general forms (graphical and textual) provide the “best of both worlds” to the researcher. This invention simultaneously meets the requirements of publishers and authors, while at the same time keeping the cost low, thereby allowing library development and scope to be maximized at an affordable rate. This low development cost also produces the side benefit of an unprecedented library growth in size. Larger libraries mean more comprehensive research, which is critical for researchers in Law, the Sciences, and Theology.

In conclusion, with this invention, digital libraries can now be affordably constructed to a scale that rivals the largest physical libraries in the world with hundreds of thousands, even to millions of volumes. This can be done while satisfying the needs of publishers, authors and researchers, and providing the essential features that make digital libraries so attractive, including full content searchability and global portability by way of the Internet.

### DRAWINGS

Not Applicable.

### Lists

Due to the nature of this invention, and the fact that it is conceptual and does not depend upon specific implementations for its validity, drawings are not necessary to describe it, and if provided, would risk limiting the scope of the invention beyond what is intended. A more representative description of this invention may be shown by listing the inexpensive, non-labor-intensive, digital forms that may be hosted in the library in lieu of the single, expensive, manually-corrected eBook or similar form. Any combination of forms in this list, provided that the first form be included along with a minimum of at least one of the other forms, are considered to be under the scope of this invention. The following list of forms are herein referred to as the “Forms List”:

### Forms List

1) Scanned or digitally photographed graphical images of each segment. (required)

2) OCR-generated textual representations of each segment without significant manual correction of OCR errors, named “OCR channels”. (optional)

3) A “super channel” that derives from the most reliable results from a comparison of multiple OCR channels. (optional)

4) A “user channel” which allows the library users to correct the OCR errors when it is in their best interest to do so, and the library may then make this user-corrected channel available to other library users. (optional)

5) A “supplied channel” that is provided to the library from some other source, such as the publisher or another eBook vendor that has a textual digital representation of the work that may be superior in accuracy to the OCR channels. (optional)

### Implementation of the Forms List

The implementation of this invention may incorporate various combinations of the forms identified herein. Those skilled in the art will recognize that the concepts of this invention may be implemented in many different ways that are equally effective in achieving the purpose of the invention. Therefore, implementation details, such as software and hardware choices, user interface design choices, etc., may vary considerably while still falling within the scope and spirit of this invention.

What is claimed is:

1. A method for hosting analog written materials in a networkable digital library comprising of three steps:
(a) digitizing segments of analog written material into a minimum of these two forms: 1) a digital form that is comprised of a graphical representation of the segment of written material, and 2) a digital form that is comprised of a textual representation of the same segment of written material; and
(b) electronically storing the written material in each of the digitized forms along with corresponding segment identifiers that associate each segment of analog material with each of the digitized forms; and
(c) making each digitized form available for display to the digital library users thereby enabling them to choose which forms to display based upon their needs.

2. The method of claim 1 wherein said analog material includes printed material.

3. The method of claim 1 wherein said analog material includes photographic film.

4. The method of claim 1 wherein said analog material includes microfiche.

5. The method of claim 1 wherein said segments are pages of written material.

6. The method of claim 1 wherein said graphical representation is comprised of pixel-based graphic data.

7. The method of claim 1 wherein said graphical representation is comprised of vector-based graphic data.

8. The method of claim 1 wherein said textual representation is initially generated from optical character recognition (OCR) software through a process consisting of 1) digitizing an analog segment into a graphical representation of the segment, followed by 2) processing the graphical representation with OCR software, which outputs a textual representation of the segment. Those skilled in the art will recognize that this initial OCR process may also be followed by human-guided OCR error-correction processes.

9. The method of claim 8 wherein said textual representation is generated multiple times for each segment, each using differing OCR software processes, programs, or configurations. The resulting textual outputs are each stored in the storage system and may each be displayed to the library user. The utility of this claim derives from the fact that some OCR processes will perform better than others on some segments, but worse than others on other segments. Offering the results of multiple OCR processes for display enables library users to view the results of each in order to find the one that yielded the best results for the segment that they are viewing. Hereinafter, the resulting outputs of each of the differing OCR processes are referred to as a “OCR channels”.

10. The method of claim 9 wherein additional textual representations are derived from other textual representations of the written material. These derived textual representations are hereinafter referred to as “super channels”. The derivation of text to be included in a super channel may be based upon any measures that help to determine the relative reliability of the textual representations that the super channels are derived from. The resulting super channel is a single textual rendering of the writings of the analog segment, with a goal of being superior in accuracy to any of the textual representations from which it was derived.

11. The method of claim 8 wherein said library users are allowed to make corrections to OCR generated text. The user-corrected textual representations of the segments of written materials are hereinafter referred to as “user channels”. This claim may have significant utility toward the purpose of this invention when it is in the library user's best interest to correct frequently-referenced segments.

12. The method of claim 1 wherein said textual representations are supplied by other available sources, hereinafter referred to as “supplied channels”. This claim may have significant utility when textual representations exist and are available from other sources (e.g. the publishers of the written materials) that exceed the quality of OCR processes.

13. The method of claim 1 wherein said textual form also includes some embedded pixel-based graphical elements. This claim may have significant utility toward the purpose of this invention when special characters and pictorial elements, which have no meaningful textual rendering, exist in the analog segment.
